(19) United States
(12) Patent Application Publication
(10) Pub. No.: US 2006/0036343 A1
(43) Pub. Date: Feb. 16, 2006

(54) Portable electronic device with fast selection

(75) Inventor: Chun Yu Chen, Taipei (TW)

Correspondence Address: EDWARDS & ANGELL, LLP, P.O. BOX 55874, BOSTON, MA, 02205, US

(73) Assignee: Inventec Multimedia & Telecom Corporation, Taipei (TW)

(21) Appl. No.: 11/205,637

(22) Filed: Aug. 16, 2005

(30) Foreign Application Priority Data
Aug. 16, 2004 (TW) 093124505

(51) Int. Cl. G06F 17/00

(52) U.S. Cl. 700/94

(57) ABSTRACT

A portable electronic device with fast selection is provided, which includes a circuit board; at least one bonding pad structure formed on the circuit board, such as a metal plate; and at least one conductive element provided corresponding to the bonding pad structure, such as a conductive plate. Different impedance signals can be provided by making the conductive element contact different positions of the bonding pad structure, which control the scrolling speed of a scrolling menu for a display of the portable electronic device. This reduces the inconvenience for repeatedly clicking the scroll and provides fast scrolling for function selections

### FIELD OF THE INVENTION

The present invention relates to portable electronic devices with fast selection, and more particularly, to a portable electronic device with a fast scrolling menu for song selections.

### BACKGROUND OF THE INVENTION

Along the evolutions of electronic technologies and integrated circuits, new types of portable electronic devices are constantly being developed, such as portable radios, portable cassette players, CD players, digital voice recorder and MP3 players etc. These portable electronic devices are becoming more versatile while the size of which keeps getting smaller.

However, along the increase of functionalities in a portable electronic device, the number of function keys required for operations increases, which limits the size reduction of the portable electronic device. Although the sizes of the function keys can be directly reduced in order to decrease the volume, the areas of the keys may become too small for users to easily operate on. However, if the operating areas of the function keys get enlarged, the total volume also increases. Some of the functionalities can be excluded, but this would reduce the variety provided by the electronic devices. Alternatively, combinational keys can be utilized to reduce the number of keys, but this approach results in more complicated operations, and sometimes it is difficult for users to memorize the sequence of pressing and the certain combinations of keys, which makes the portable electronic device impractical to be used.

Accordingly, if the portable electronic device has many functions, such as language and time settings etc., it would be helpful to add a display to the electronic device, such as a self-colored or colored LCD, such that operating functions can be displayed and complicated operating steps can be guided by a software program in order to eliminate the need for memorizing the operating procedure and also reduce the number of function keys used. Furthermore, the operating steps can be replaced by providing a menu-type software program, so that the size of the portable electronic product can be reduced for portability.

Besides replacing setting functions by a program as described above, other commonly used basic operating keys can also be replaced. However, selecting commonly used keys via a software program may not be very convenient. For example, commonly used keys such as Play, Forward, or Backward are usually physically designed on the casing, while the other less commonly used functions are implemented via software program. If keys are directional, then the correct direction has to be assured during operation to avoid pressing the wrong keys. Operating keys may also be accidentally pressed, such that operations can be interrupted by uncertain factors.

In order to solve the problems of portable electronic devices having too many operating keys, which results in bulk sizes that are uneasy to be carried around or unattractive in the market, and exposed operating keys being accidentally touched, U.S. Pat. No. 6,639,584 discloses a portable electronic device as shown in FIG. 6A and FIG. 6B. Referring to FIG. 6A, an music player 30 is shown, such as a MP3 player, a CD player, a DVD player, a cassette player, or a voice recorder etc. A touch pad 32 and a LCD display 33 are equipped on a housing 31. A headphone jack 34 and a data port 35 are also provided on the housing 31. Patterns representing control signals can be drawn by users on the touch pad 32, such as left/right broken lines, left/right straight lines or clockwise/anti-clockwise circles. Thereupon, music player 30 can execute actions according to the patterns entered, such as play, forward, backward, or repeat etc, and the actions being executed can be displayed on the LCD display 33, such that the number of key can be reduced or entirely eliminated. The touch pad 32 for inputting control patterns and the LCD display 33 for showing current operating status are two separate elements. Referring then to FIG. 6B, where said two functions are integrated into a single touch screen 36 both for input and display. Users can similarly draw control patterns on the touch screen 36 to operate the music player 30.

The above method of controlling the music player 30 via drawing on the touch pad 32 or the touch screen 36 to input control patterns can reduce the number of keys. However, the area of the touch pad 32 or the touch screen 36 cannot be too small, otherwise it would be uneasy to draw control patterns thereon, and also small patterns may not be recognized as easily as the larger ones. Thus, the size reduction of this type of music player 30 is still limited.

Although drawing control patterns on the touch pad 32 or the touch screen 36 is convenient and reduces the risks of being activated accidentally. However, patterns drawn on the touch pad 32 or the touch screen 36 can sometimes be too rough to be recognized. This creates perturbation when in use.

Current techniques regarding memory chips are getting more and more matured, where memory capacity is nearly as large as that of a small hard disk. Thus, a MP3 player with a size of a finger has about 2 GB to 4 GB of memory capacity. For a MP3 format, playing length of a one-minute song approximately equals a size of 1 MB. Therefore, hundreds of songs can be stored in memories with large capacity. Even higher storage capacity can be obtained by storing the songs in WMA format. Thus, songs have to be selected before played. However, if the traditional method of clicking keys or drawing control patterns repeatedly one after the other is used, it would take a long time to make selections, which negates the purpose of having large-capacity memory for song storage.

If hard disks are used as storage media of the portable players, the sizes can reach up to tens of GB. Although, this saves time spent in changing storage media as required in the case of a CD or a cassette player, it would be very difficult and time-consuming to select songs from such a huge collections of music using the conventional way of inputting one-by-one.

Moreover, if selections are made through clicking, then each time the user clicks a key, the next song or page is displayed, such that a series of sequential clicking has to be performed. This may cause uneasiness for the user's finger. Also, the mechanical keys tend to wear out more easily with time, resulting in imperfect contacts, which in turns requires more clicking to make contact work and this generates even faster wear out.

Thus, there is a need for a product that enables selections of desired songs from a large collection of songs more quickly and easily.

### SUMMARY OF THE INVENTION

In the light of forgoing drawbacks, a primary objective of the present invention is to provide a portable electronic device that enables fast scrolling of a menu.

Another objective of the present invention is to provide a portable electronic device with a circuit board, wherein at least one bonding pad structure is formed on the circuit board to provide a rotatable dial structure with variable impedances, and by thinning of the bonding pad structure, a small-sized electronic device with a rotatable dial for fast selection of functions can be provided.

In order to achieve the above and other objectives, a preferred embodiment of the present invention comprises: a housing; a movable element provided on a surface of the housing; a circuit board disposed in the housing; at least one bonding pad structure formed on the circuit board; a plurality of conductive elements fixed to the bottom of the movable element contacting the corresponding at least one bonding pad structure, wherein operating the movable element changes the contact positions between the conductive elements and the corresponding at least one bonding pad structure; a detecting unit disposed on the circuit board and connected with the conductive elements and the at least one bonding pad structure for detecting an output sensing signal, wherein the magnitude of the output sensing signal depends on the contact positions between the conductive elements and the at least one bonding pad structure; a converting unit provided on the circuit board and connected with the detecting unit for converting the detected signal; and a control unit provided on the circuit board and connected with the converting unit for receiving the converted signal from the converting unit and outputting a control signal.

In the above embodiment, the conductive elements can be conductive plates contacting the at least one bonding pad structure on the circuit board, wherein the contact positions between the conductive elements and the at least one bonding pad structure can be varied by moving the movable element attached to the conductive elements, such that different magnitudes of impedance signals can be detected by the detecting unit, converted by the converting unit and then sent to the control unit. Thereby, the control unit controls the speed of scrolling of a data menu according to the magnitude of the received signals, so that fast selection of functions can be achieved, avoiding the trouble of selecting only one function upon one input action in the prior art.

Moreover, the movable element allows the conductive elements to contact different positions of the at least one bonding pad structure by rotational or translational movements thereof, which results in different magnitudes of signals being outputted for controlling the scrolling speed of the data menu. The conventional method of repeatedly clicking the same keys can be avoided by rotating or shifting the movable element to fixed points, thus reducing the wear out problem and extending the usage life of mechanical parts.

### BRIEF DESCRIPTION OF THE DRAWINGS

The present invention can be more fully understood by reading the following detailed description of the preferred embodiments, with reference made to the accompanying drawings, wherein:

FIG. 1A shows a top view of a circuit board formed with arc-shaped metal plates of a portable electronic device with fast selection according a first embodiment of the present invention;

FIG. 1B shows a top view of a circuit board formed with bar-shaped metal plates of a portable electronic device with fast selection according a second embodiment of the present invention;

FIG. 2 is a side view of the circuit board of the portable electronic device with fast selection according to the present invention;

FIG. 3A is a schematic 3-D diagram of the portable electronic device with fast selection according to the first embodiment of the present invention;

FIG. 3B is a schematic 3-D diagram of the portable electronic device with fast selection according to the second embodiment of the present invention;

FIG. 4A is a sectional view of a portion of the portable electronic device with fast selection according to the first embodiment of the present invention;

FIG. 4B is a sectional view of a portion of the portable electronic device with fast selection according to the second embodiment of the present invention;

FIG. 5 is a block diagram of the portable electronic device with fast selection according to the present invention;

FIG. 6A (PRIOR ART) is a perspective schematic diagram of a music player disclosed in U.S. Pat. No. 6,639,584; and

FIG. 6B (PRIOR ART) is a perspective schematic diagram of another music player disclosed in U.S. Pat. No. 6,639,584.

### DETAILED DESCRIPTION OF THE EMBODIMENTS

The following embodiments are described in details to illustrate aspects of the present invention, but they are not to be construed as to limit the present invention in any way.

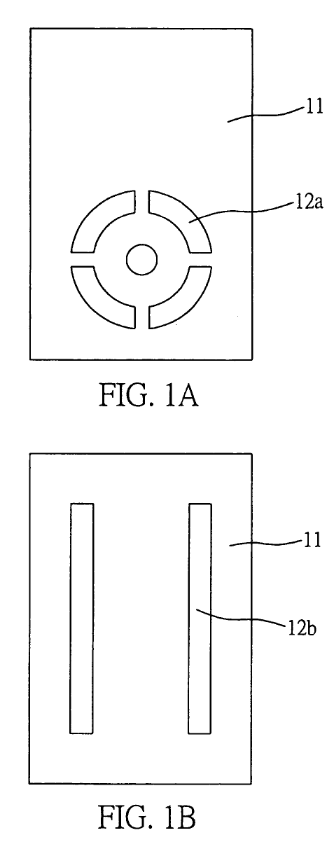

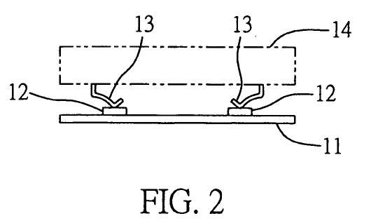

Referring to FIGS. 1A, 1B and 2, top views and a side view of the circuit board according to the present invention are shown, respectively. The portable electronic device with fast selection of the present invention comprises a circuit board 11, at least one bonding pad structure 12 formed on the circuit board 11, such as an arc-shaped metal plate 12a shown in FIG. 1A or a bar-shaped metal plate 12b shown in FIG. 1B, and a conductive element 13 corresponding to bonding pad structure 12, such as a conductive plate. A power supply (not shown) is also connected to the circuit board 11, such as a battery or an external power supply.

When power passes through the conductive element 13, the resistance is R=ρ (A/L), such that when the conductive element 13 contacts different positions of the bonding pad structure 12, such as the front end, middle or rear end of the bonding pad structure 12, the combined resistance is different. Additionally, according to the current basic law V=IR, when current (I) is constant and the resistance (R) decreases or increases, then the output voltage (V) decreases or increases according to the resistance. That is, the voltage and resistance are proportional to each other. Conversely, when the voltage is constant and the resistance increases or decreases, then the output current decreases or increases inversely proportional to the resistance. Accordingly, when the conductive element 13 is at the front end, middle or rear end (or any other positions) of the bonding pad structure 12, a different output current or voltage can be detected, and such current or voltage variations can be used as control signals.

In the previous descriptions, the bonding pad structure 12 is directly formed on the circuit board 11, which combined with a conductive plate, such as the thin conductive element 13, form a device for inputting signals.

### First Embodiment

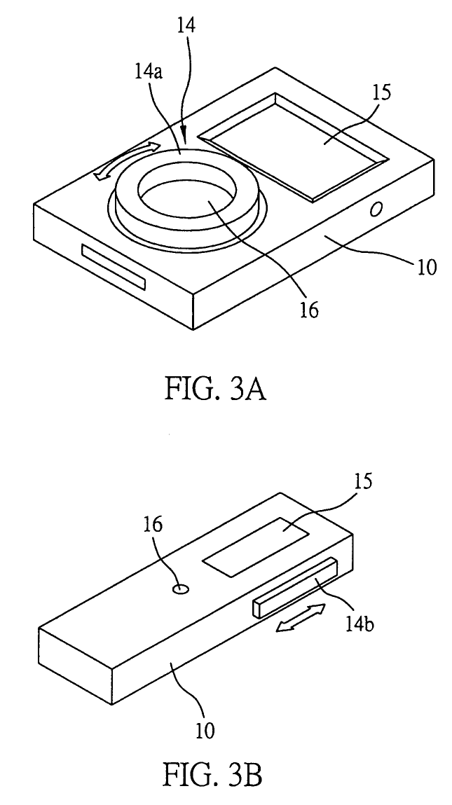

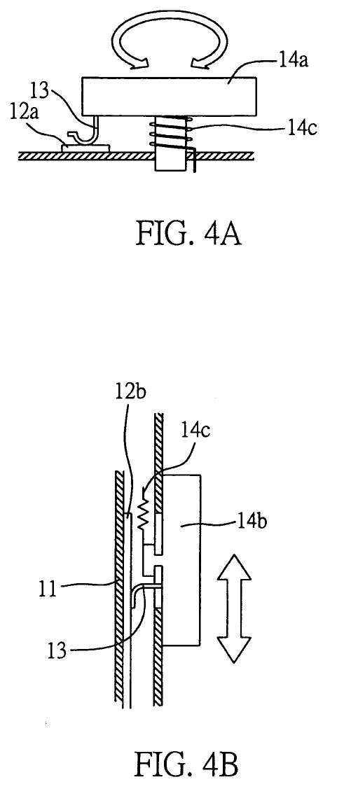

Referring to FIG. 3A, a three-dimensional outside view of the present invention is schematically shown. A movable element 14 is formed on the surface of a housing 10, and a display unit 15 is also provided on the surface of the housing 10. Referring back to FIGS. 1A and 2, the circuit board 11 is equipped inside the housing 10, arc-shaped metal plates 12a are arranged in circle on the circuit board 11. The conductive elements 13 are provided under the movable element 14 and lean on the arc-shaped metal plates 12a. Referring now to FIG. 4A, the movable element 14 is a circular dial 14a, and an elastic element 14c, such as a torsional spring, is provided on the axis of the dial 14a, such that the dial 14a rotates and the conductive elements 13 of the conductive plate structure slide along on the arc-shaped metal plates 12a. The dial 14a automatically returns to its original position after rotation via the elastic element 14c.

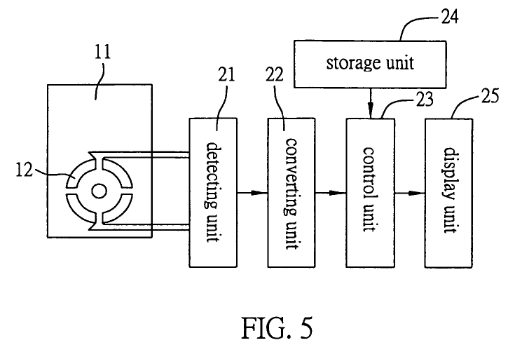

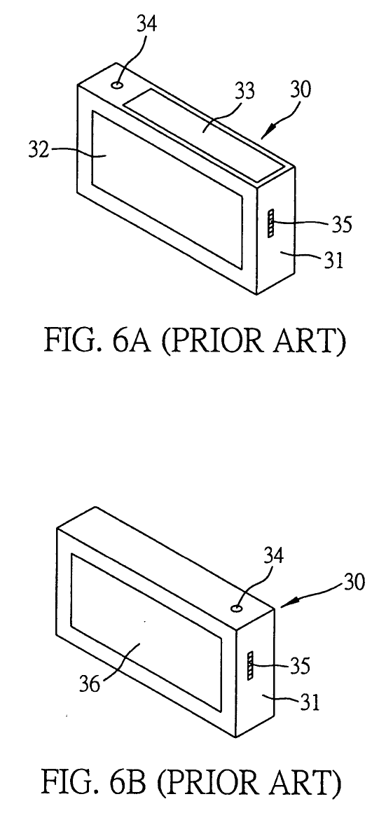

Referring to FIG. 5, the device for inputting signals formed by the described bonding pad structures 12 and the conductive elements 13 is connected to a detecting unit 21 provided on the circuit board 11. Power signals (e.g. voltage or current signals) are detected by the detecting unit 21. Then the voltage or current analog signals detected by the detecting unit are converted into digital signals by a converting unit 22 provided on the circuit board 11 and the digital signals are sent to a control unit 23 provided on the circuit board 11. The control unit 23 is connected to a storage unit 24, which is a high capacity flash memory or a hard disk, and the control unit 23 is also connected to a display unit 25 for displaying signals. The control unit 23 controls the speed at which data stored in the storage unit 24 are displayed on the display unit 25 based on the magnitude of the converted signals sent by the converting unit 22.

The data stored in the storage unit 24 is a song menu or other data menu that can be scrolled forward or backward at a lower or a higher speed according to how far left or right the dial 14a is turned. Thereby, users are allowed to quickly browse through the song menu, avoiding finger pain and wear out of mechanical keys caused by pressing input keys repeatedly in the prior art.

### Second Embodiment

Referring to FIGS. 1B, 3B and 4B, which shows another embodiment of the present invention. This embodiment differs from the previous embodiment in that the movable element 14 is a push button 14b that can slide back and forth in straight line and similarly after being pushed, the push button 14b returns to its origin via the force of an elastic member, such as a spring. A conductive element 13 underneath the movable element 14 contacts a bar-shaped metal plate 12b, such that the conductive element 13 abuts against the bar-shaped metal plate 12b at different positions thereon via sliding the push button 14b back and forth. This creates variations in the voltage or current signals, which after being converted by the converting unit 22 from analog to digital are sent to the control unit 23 for signal control, so that the menu stored in the storage unit 24 can be scrolled forward or backward at various speed, enables the users to search data quickly.

Referring to FIG. 3A again, a confirm key 16 is arranged on the center of the dial 14a or on the housing 10 as shown in FIG. 3B, so that after a selection is made, the confirm key can be pressed for confirmation. The data process after selection or the mode presented by the menu before selection depends on the specific software program employed, which will not be described further for clarity.

The above-described embodiments are only used to illustrate the various features and effects of the present invention. Other advantages and effects will be readily appreciated by those skilled in the art via the detailed description disclosed in this specification. The present invention can be practiced by other embodiments, and should therefore cover various modifications and variations made to the herein-described details of the present invention, provided they fall within the scope of the present invention as defined in the following appended claims.

What is claimed is:

1. A portable electronic device with fast selection, comprising:
a housing;
a movable element provided on a surface of the housing;
a circuit board disposed in the housing;
at least one bonding pad structure formed on the circuit board;
a plurality of conductive elements fixed to the movable element and being in contact with the bonding pad structure, wherein contact positions between the conductive elements and the bonding pad structure are changed by moving the movable element;
a detecting unit disposed on the circuit board and connected to the conductive elements and the bonding pad structure so as to detect an output sensing signal corresponding to the contact positions between the conductive elements and the bonding pad structure, wherein magnitude of the output sensing signal is variable depending on the change of the contact positions between the conductive elements and the bonding pad structure;
a converting unit provided on the circuit board and connected to the detecting unit so as to convert the detected output sensing signal; and
a control unit provided on the circuit board and connected to the converting unit so as to receive the converted signal from the converting unit and output a control signal.

2. The portable electronic device with fast selection of claim 1, wherein the circuit board comprises a storage unit for storing data and connected to the control unit.

3. The portable electronic device with fast selection of claim 2, wherein the storage unit comprises a flash memory.

4. The portable electronic device with fast selection of claim 2, wherein the storage unit comprises a hard disk.

5. The portable electronic device with fast selection of claim 1, wherein the housing comprises a display unit connected to the control unit.

6. The portable electronic device with fast selection of claim 1, wherein the bonding pad structure is an arc-shaped metal plate or a bar-shaped metal plate.

7. The portable electronic device with fast selection of claim 6, wherein the at least one bonding pad structure comprises a plurality of the arc-shaped metal plates arranged in a circle.

8. The portable electronic device with fast selection of claim 1, wherein the conductive elements comprises conductive plates.

9. The portable electronic device with fast selection of claim 1, wherein the movable element comprises a rotatable dial and an elastic member for allowing the rotatable dial to return back to its starting position after being rotated.

10. The portable electronic device with fast selection of claim 9, wherein the elastic member comprises a torsional spring.

11. The portable electronic device with fast selection of claim 1, wherein the movable element comprises a push button capable of sliding in a straight line, and an elastic member for allowing the push button to return to its starting position after being slid.

12. The portable electronic device with fast selection of claim 11, wherein the elastic member comprises a spring.
